(19) United States
(12) Patent Application Publication
(10) Pub. No.: US 2007/0085795 A1
(43) Pub. Date: Apr. 19, 2007

(54) Display Device And Related Driving Circuits

(76) Inventors: Hsin-Ta Lee, Taoyuan County (TW); Yung-Chou Chan, Chang-Hua Hsien (TW)

Correspondence Address: NORTH AMERICA INTELLECTUAL PROPERTY CORPORATION, P.O. BOX 506, MERRIFIELD, VA, 22116, US

(21) Appl. No.: 11/278,962

(22) Filed: Apr. 6, 2006

(30) Foreign Application Priority Data
Oct. 17, 2005 (TW) 094136166

(51) Int. Cl. G09G 3/36

(52) U.S. Cl. 345/92

(57) ABSTRACT

A driving circuit of a display panel includes a plurality of data lines equidistantly arrayed in a substrate of the display panel and including a plurality of first data lines and a plurality of second data lines, a plurality of scan lines equidistantly arrayed in the substrate and perpendicular to the plurality of the data lines, a plurality of first thin-film transistors coupled to a first side of a scan line of the plurality of the scan lines and the plurality of the first data lines for controlling pixels in the first side of the scan line, and a plurality of second thin-film transistors coupled to a second side of the scan line and the plurality of the second data lines for controlling pixels in the second side of the scan line.

### BACKGROUND OF THE INVENTION

1. Field of the Invention

The present invention relates to a display device, and more particularly, to a display device having the same quality of a dot inversion driving method and the same power consumption of a line inversion driving method.

2. Description of the Prior Art

The advantages of a liquid crystal display (LCD) include lighter weight, less electrical consumption, and less radiation contamination. Thus, the LCD monitors have been widely applied to various portable information products, such as notebooks, PDAs, etc. In an LCD monitor, incident light produces different polarization or refraction effects when the alignment of liquid crystal molecules is altered. The transmission of the incident light is affected by the liquid crystal molecules, and magnitude of the light emitting out of liquid crystal molecules varies. The LCD monitor utilizes the characteristics of the liquid crystal molecules to control the corresponding light transmittance and produces gorgeous images according to different magnitudes of red, blue, and green light.

Please refer to FIG. 1, which illustrates a schematic diagram of a prior art thin film transistor (TFT) LCD monitor 10. The LCD monitor 10 includes an LCD panel 12, a control circuit 14, a data-line-signal output circuit 16, a scan-line-signal output circuit 18, a first voltage generator 20, and a second voltage generator 22. The LCD panel 12 is constructed by two parallel substrates. There is an LCD layer located in the space between these two substrates. A plurality of data lines 24, a plurality of scan lines 26 that are perpendicular to the data lines 24, and a plurality of TFTs 28 are positioned on one of the substrates. There is a common electrode installed on another substrate, and the first voltage generator 20 is electrically connected to the common electrode for outputting a common voltage Vcom via the common electrode. Please note that only four TFTs 28 are shown in FIG. 1 for clarity. Actually, the LCD panel 12 has one TFT 28 installed in each intersection of the data lines 24 and scan lines 26. In other words, the TFTs 28 are arranged in a matrix format on the LCD panel 12. The data lines 24 correspond to different columns, and the scan lines 26 correspond to different rows. The LCD monitor 10 uses a specific column and a specific row to locate the associated TFT 28 that corresponds to a pixel. In addition, the structure of the LCD panel 12, that is, two substrates with one LCD layer is equivalent to a capacitor 30. The substrates function as conductive plates, and the stuffed LCD layer functions as a dielectric.

The operation of the prior art LCD monitor 10 is described as follows. When the control circuit 14 receives a horizontal synchronization signal 32 and a vertical synchronization signal 34, the control circuit 14 generates corresponding control signals respectively inputted into the data-line-signal output circuit 16 and the scan-line-signal output circuit 18. The data-line-signal output circuit 16 and the scan-line-signal output circuit 18 then generate input signals to the LCD panel 12 for turning on the corresponding TFTs 28, and changing the alignment of liquid crystal molecules and light transmittance so that a voltage difference will be kept by the capacitors 30, and image data 36 is displayed in the LCD panel 12. For example, the scan-line-signal output circuit 18 outputs a pulse to the scan line 26 for turning on the TFT 28. Therefore, the voltage of the input signal generated by the data-line-signal output circuit 16 is inputted into the capacitor 30 through the data line 24 and the TFT 28. The voltage difference kept by the capacitor 30 can further adjust a corresponding gray level of the related pixel through affecting the related alignment of liquid crystal molecules positioned inside the LCD layer. In addition, the data-line-signal output circuit 16 generates the input signals, and magnitude of each input signal inputted to the data line 24 is controlled by the second voltage generator 22. Different voltage levels generated by the second voltage generator 22, therefore, correspond to different gray levels.

If the LCD monitor 10 continuously uses a positive voltage to drive the liquid crystal molecules, the liquid crystal molecules will not quickly change a corresponding alignment according to the applied voltages as before. Thus, the incident light will not produce accurate polarization or refraction, and the quality of images displayed on the LCD monitor 10 deteriorates. Similarly, if the LCD monitor 10 continuously uses a negative voltage to drive the liquid crystal molecules, the liquid crystal molecules will not quickly change a corresponding alignment according to the applied voltages as before. Thus, the incident light will not produce accurate polarization or refraction, and the quality of images displayed on the LCD monitor 10 deteriorates. In order to protect the liquid crystal molecules from being irregular, the LCD monitor 10 must alternately use positive and the negative voltages to drive the liquid crystal molecules. In addition, not only does the LCD panel 12 have the capacitors 30, but the related circuit will also have some parasite capacitors owing to its intrinsic structure. When the same image is displayed on the LCD panel 12 for a long time, the parasite capacitors will be charged to generate a residual image effect. The residual image with regard to the parasite capacitors will further distort the following images displayed on the same LCD panel 12. Therefore, the LCD monitor 10 must alternately use the positive and the negative voltage to drive the liquid crystal molecules for eliminating the undesired residual image effect. However, when the LCD monitor 10 alternately uses the positive and negative voltage to drive the liquid crystal molecules, the image displayed will flicker owing to a voltage offset generated by the TFT 28. The reason is described as follows.

In order to solve the mentioned problem when the LCD monitor 10 alternatively uses the positive and negative voltages to driving the liquid crystal molecules, the LCD monitor 10 adopts different driving methods to eliminate the image flickers. Please refer to FIG. 2 to FIG. 5. FIG. 2 and FIG. 3 are diagrams of a prior art line inversion driving method. FIG. 4 and FIG. 5 are diagrams of a prior art dot inversion driving method. In FIG. 2 and FIG. 3, blocks 200 and 300 show polarities of pixels in the same part of two successive image frames, and polarities of pixels in a line are uniform and change to opposite polarities as a frame changes. In FIG. 4 and FIG. 5, blocks 400 and 500 show polarities of pixels in the same part of two successive image frames, and polarities of adjacent pixels are different, and the polarity of a pixel changes to an opposite polarity as a frame changes. The line inversion driving method can eliminate image flickers along the vertical direction, and the dot inversion driving method can eliminate image flickers along the vertical direction and the horizontal direction simultaneously for improving corresponding image quality. Therefore, the dot inversion driving method achieves better image quality than the line inversion driving method. However, the dot inversion driving method consumes more power than the line inversion driving method does, so that applications of the dot inversion driving method are limited, especially in portable electric devices.

### SUMMARY OF THE INVENTION

It is therefore a primary objective of the claimed invention to provide a display device and related driving circuits.

The present invention discloses a driving circuit of a display panel. The driving circuit includes a plurality of data lines equidistantly arrayed in a substrate of the display panel and including a plurality of first data lines and a plurality of second data lines, a plurality of scan lines equidistantly arrayed in the substrate and perpendicular to the plurality of the data lines, a plurality of first thin-film transistors coupled to a first side of a scan line of the plurality of the scan lines and the plurality of the first data lines for controlling pixels in the first side of the scan line, and a plurality of second thin-film transistors coupled to a second side of the scan line and the plurality of the second data lines for controlling pixels in the second side of the scan line.

The present invention further discloses a display device. The display device includes a display panel, a first signal output circuit, a second signal output circuit, and a control circuit. The display panel includes a first substrate, a second substrate including a common electrode for providing a stable voltage, a plurality of data lines equidistantly arrayed in the first substrate of the display panel and including a plurality of first data lines and a plurality of second data lines, a plurality of scan lines equidistantly arrayed in the first substrate and perpendicular to the plurality of the data lines, a plurality of first thin-film transistors coupled to a first side of a scan line of the plurality of the scan lines and the plurality of the first data lines for controlling pixels in the first side of the scan line, and a plurality of second thin-film transistors coupled to a second side of the scan line and the plurality of the second data lines for controlling pixels in the second side of the scan line. The first signal output circuit outputs signals to the plurality of the data lines according to image data and a first control signal. The second signal output circuit outputs signals to the plurality of the scan lines according to a second control signal. The control circuit outputs the first control signal and the second control signal according to a horizontal synchronization signal and a vertical synchronization signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior art thin film transistor LCD monitor.

FIG. 2 and FIG. 3 illustrate schematic diagrams of a prior art line inversion driving method.

FIG. 4 and FIG. 5 illustrate schematic diagrams of a prior art dot inversion driving method.

FIG. 6 illustrates a schematic diagram of a display device in accordance with the present invention.

FIG. 7 illustrates a schematic diagram of a display panel of a dot inversion driving method in accordance with a preferred embodiment of the present invention.

FIG. 8 and FIG. 9 illustrate schematic diagrams of a two-dot line inversion driving method.

FIG. 10 illustrates a display panel in accordance with an embodiment of the present invention.

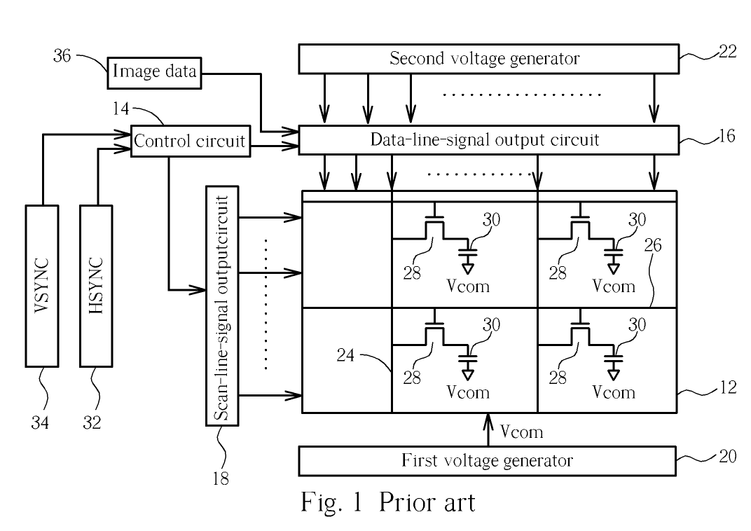

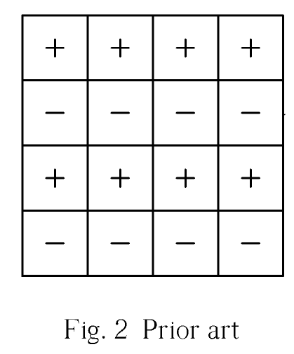

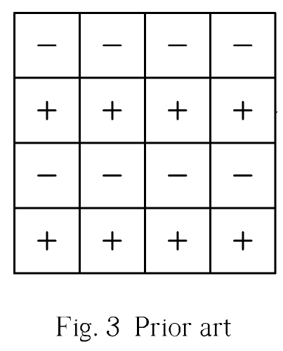

### DETAILED DESCRIPTION

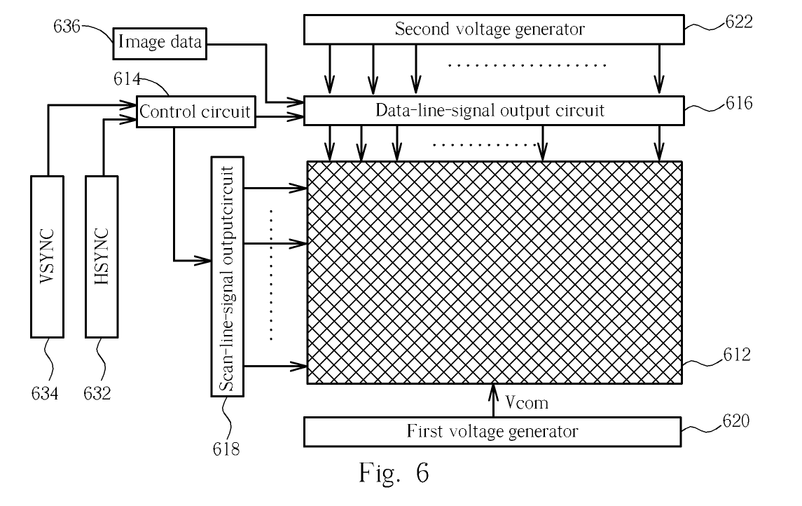

Please refer to FIG. 6, which illustrates a schematic diagram of a display device 600 in accordance with the present invention. The display device 600 has advantages of low-power consumption and high image quality, and includes a display panel 612, a control circuit 614, a data-line-signal output circuit 616, a scan-line-signal output circuit 618, a first voltage generator 620, and a second voltage generator 622. The display panel 612 is constructed by two parallel substrates, and there is an LCD layer located in the space between these two substrates. A plurality of data lines, a plurality of scan lines that are perpendicular to the data lines, and a plurality of TFTs are positioned on one of the substrates. There is a common electrode installed on another substrate, and the first voltage generator 620 is electrically connected to the common electrode for outputting a common voltage Vcom via the common electrode.

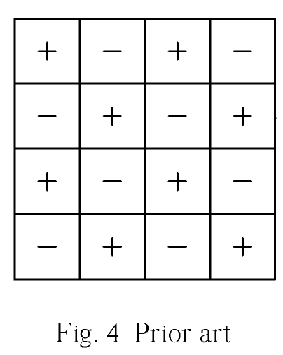

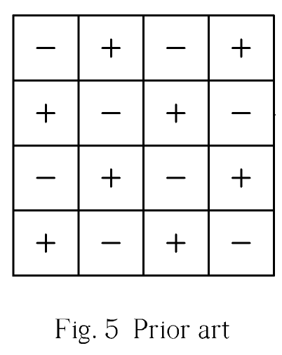

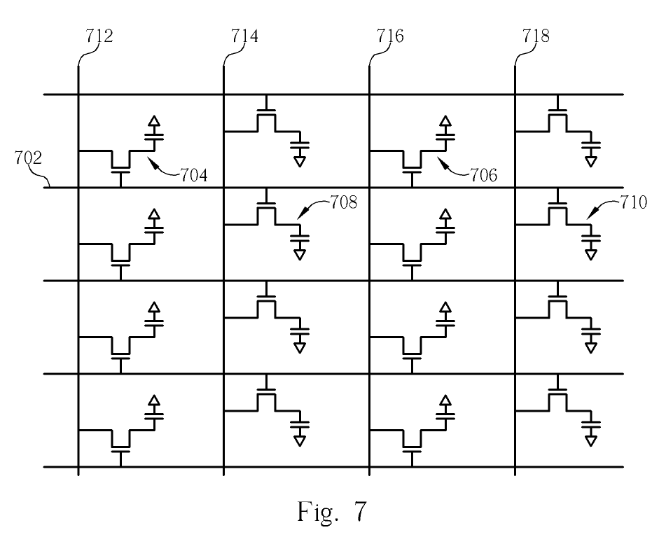

In the display panel 612, a TFT is installed in an intersection of a data line and a scan line. According to different driving methods, the present invention changes arrangement of the TFTs in the display panel 612. For example, please refer to FIG. 7, which illustrates a schematic diagram of a display panel 700 of the dot inversion driving method in accordance with a preferred embodiment of the present invention. The display panel 700 can be used for implementing the display panel 612. For clarity, FIG. 7 shows a portion of the display panel 700. In the display panel 700, TFTs corresponding to a scan line control pixels in two sides of the scan line interlacedly. Therefore, in FIG. 7, intersections of a scan line 702 and each data line are TFTs 704, 706, 708, and 710. Output voltages of the TFT 704 and the TFT 706 controls upper pixels of the scan lines 702, and output voltages of the TFT 708 and the TFT 710 control lower pixels of the scan line 702. Similarly, arrangements of TFTs in other scan lines are same as the TFTs in the scan line 702. As a result, driving the display panel 700 with the line inversion driving method can achieve properties of the dot inversion driving method (as shown in FIG. 4 and FIG. 5), because adjacent pixels in a row are driven by different scan lines. That is, polarities of adjacent pixels are different, and a polarity of a pixel change to an opposite polarity with frame alternation. As mentioned above, the dot inversion driving method has better image quality but consumes more power than the line inversion driving method does. By changing arrangement of the TFTs in the display panel, the present invention can get the same quality of the dot inversion driving method with low power consumption of the line inversion driving method. In addition, to synchronize timings of pixels in a row, timings of signals of the data lines 714 and 718 are advanced to that of the data lines 712 and 716 with one cycle. Furthermore, the last scan line in the display panel 700 can be coupled to the first scan line to save resources on outputting signals to the last scan line.

Therefore, if the display panel 612 in FIG. 6 is implemented by the display panel 700 in FIG. 7, when the control circuit 614 receives a horizontal synchronization signal 632 and a vertical synchronization signal 634, the control circuit 614 generates corresponding control signals respectively inputted into the data-line-signal output circuit 616 and the scan-line-signal output circuit 618. The data-line-signal output circuit 616 and the scan-line-signal output circuit 618 then generate input signals for turning on the corresponding TFTs, and changing the alignment of liquid crystal molecules and light transmittance, and image data 636 is displayed in the LCD panel 12. Magnitudes of signals inputted from the data-line-signal output circuit 616 to the data lines of the display panel 700 are controlled by the second voltage generator 622. Different voltage levels generated by the second voltage generator 622, therefore, correspond to different gray levels.

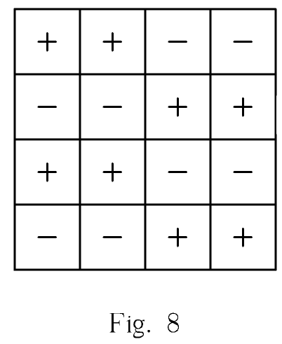

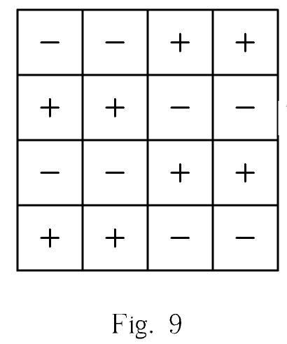

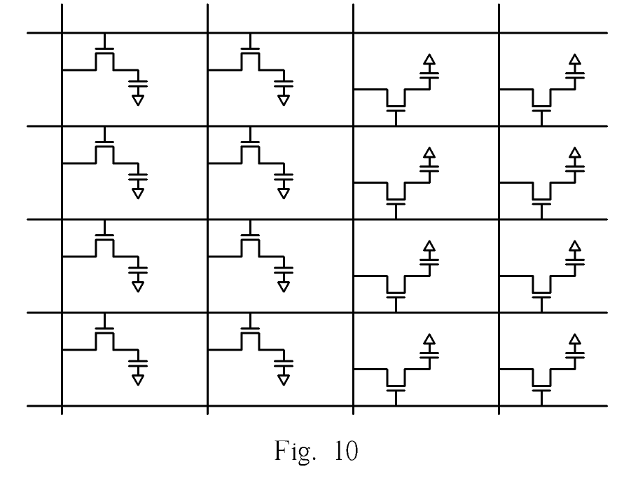

Using the present invention display panel 700, the display device 600 can reach the image quality of the dot inversion driving method with power consumption of the line inversion driving method. The display panel 700 herein is an exemplary embodiment for implementing different driving methods by changing arrangement of the TFTs in the display panel. Those skilled in the art can modify and alter arrangement of the TFTs in the display panel in response to the driving methods. For example, please refer to FIG. 8 and FIG. 9, which illustrate schematic diagrams of a two-dot line inversion driving method. In FIG. 8 and FIG. 9, blocks 800 and 900 show polarities of pixels in the same part of two successive image frames, polarities of each two adjacent pixels in a line change to opposite polarities as a frame changes. Please refer to FIG. 10, which illustrates a display panel 1000 in accordance with an embodiment of the present invention. In the display panel 1000, TFTs corresponding to a scan line are divided into sets every two TFTs. Therefore, when driving the display panel 1000 by the line inversion driving method, the display panel 1000 presents the image quality of the two-dot line inversion driving method.

In summary, by changing arrangement of the TFTs in the display panel, the present invention can achieve high quality with low power consumption, and therefore saves system resources, especially for portable electric devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving circuit of a display panel comprising:
a plurality of data lines equidistantly arrayed in a substrate of the display panel and comprising a plurality of first data lines and a plurality of second data lines;
a plurality of scan lines equidistantly arrayed in the substrate and perpendicular to the plurality of the data lines;
a plurality of first thin-film transistors coupled to a first side of a scan line of the plurality of the scan lines and the plurality of the first data lines for controlling pixels in the first side of the scan line; and
a plurality of second thin-film transistors coupled to a second side of the scan line and the plurality of the second data lines for controlling pixels in the second side of the scan line.

2. The driving circuit of claim 1, wherein the first side and the second side are opposite sides of the scan line.

3. The driving circuit of claim 1, wherein the plurality of the first data lines and the plurality of the second data lines are arrayed interlacedly.

4. The driving circuit of claim 1, wherein the plurality of the first data lines and the plurality of the second data lines are arrayed interlacedly one set by one set.

5. The driving circuit of claim 1, wherein timings of signals of the plurality of the first data lines lag a duration behind timings of signals of the plurality of the second data lines.

6. The driving circuit of claim 5, wherein the duration is a cycle.

7. The driving circuit of claim 1, wherein a first scan line of the plurality of the scan lines is coupled to a last scan line of the plurality of the scan lines.

8. A display device comprising:
a display panel comprising:
a first substrate;
a second substrate comprising a common electrode for providing a stable voltage;
a plurality of data lines equidistantly arrayed in the first substrate of the display panel and comprising a plurality of first data lines and a plurality of second data lines;
a plurality of scan lines equidistantly arrayed in the first substrate and perpendicular to the plurality of the data lines;
a plurality of first thin-film transistors coupled to a first side of a scan line of the plurality of the scan lines and the plurality of the first data lines for controlling pixels in the first side of the scan line; and
a plurality of second thin-film transistors coupled to a second side of the scan line and the plurality of the second data lines for controlling pixels in the second side of the scan line.
a first signal output circuit for outputting signals to the plurality of the data lines according to image data and a first control signal;
a second signal output circuit for outputting signals to the plurality of the scan lines according to a second control signal; and
a control circuit for outputting the first control signal and the second control signal according to a horizontal synchronization signal and a vertical synchronization signal.

9. The display device of claim 8, wherein the first side and the second side are opposite sides of the scan line.

10. The display device of claim 8, wherein the plurality of the first data lines and the plurality of the second data lines are arrayed interlacedly.

11. The display device of claim 8, wherein the plurality of the first data lines and the plurality of the second data lines are arrayed interlacedly one set by one set.

12. The display device of claim 8, wherein the control circuit controls timings of signals of the plurality of the first data lines to lag a duration behind timings of signals of the plurality of the second data lines through the first signal output circuit.

13. The display device of claim 12, wherein the duration is a cycle.

14. The display device of claim 8, wherein a first scan line of the plurality of the scan lines is coupled to a last scan line of the plurality of the scan lines.

15. The display device of claim 8 further comprising a first voltage generator for outputting the stable voltage.

16. The display device of claim 8 further comprising a second voltage generator for outputting voltage to the plurality of the data lines for controlling signal magnitudes of the plurality of the data lines.
